(19) United States
(12) Patent Application Publication
(10) Pub. No.: US 2009/0071227 A1
(43) Pub. Date: Mar. 19, 2009

(54) METHOD FOR DETERMINING THE TIRE DIAMETERS OF A MOTOR VEHICLE

(76) Inventors: Dirk Schmid, Simmozheim (DE); Marcus Schneider, Ludwigsburg (DE)

Correspondence Address: KENYON & KENYON LLP, ONE BROADWAY, NEW YORK, NY, 10004, US

(21) Appl. No.: 12/090,604

(22) PCT Filed: Sep. 19, 2006
(86) PCT No.: PCT/EP2006/066501

§ 371 Date: Oct. 14, 2008

(30) Foreign Application Priority Data
Nov. 14, 2005 (DE) 10 2005 054 141.0

(51) Int. Cl. G01B 7/12

(52) U.S. Cl. 73/1.79

(57) ABSTRACT

A method and control for determining the tire diameters of a motor vehicle by comparing at least two opposite wheels. To provide the lowest possible measuring effort while simultaneously ensuring the highest possible precision, a driving maneuver including at least one cornering operation is defined as calibration drive, and the change in the vehicle orientation in the calibration drive is determined. The control includes sensors to determine the change in the vehicle orientation in a calibration drive.

### FIELD OF THE INVENTION

The present invention relates to a method and to a device for determining the tire diameters of a motor vehicle by comparing at least two opposite wheels.

### BACKGROUND INFORMATION

Such a method is described in German Patent No. DE 3738914 A1. It describes a method for correcting the wheel speeds of a vehicle, which are determined by wheel sensors but differ from each other due to different wheel diameters.

In general, a datum regarding the tire diameter of the reference wheel(s) is required in order to determine the vehicle speed and/or the traveled distance. This information is stored in at least one control device and set into relation with the measured wheel rotation and the rotational wheel speed derived therefrom. In today's motor vehicles this information is stored on a vehicle bus, e.g., a CAN bus, in the form of numerical values. The functions connected thereto, such as, for example, the parking-space measurement (PSM) and the semi-autonomous parking assistant (PA), utilize this information to calculate the vehicle position at any given time on the basis of this data. An error in the information pertaining to the tire diameter will cause an error in the determined position. This may result in accidents, for instance when a steering control takes place on the basis of faulty positional data.

The tire diameter must therefore be calibrated. Generally, the calibration is implemented in such a way that either the tire diameter or the tire circumference is measured directly. As an alternative, a reference route is driven and the wheel rotations required for this purpose are set into relation with the driven distance. The disadvantage of such direct measurement methods is that a precise length measurement, such as the tire diameter, the tire circumference or the reference route must have taken place. This requires additional measuring components and a correspondingly high precision in the implementation of the length measurement.

### SUMMARY

It is an object of the present invention to provide a method for determining the tire diameter that requires minimal measuring effort but simultaneously offers the highest possible accuracy.

This object may be achieved by a method for determining the tire diameters of a motor vehicle by comparing at least two opposite wheels, in which a driving maneuver including at least one cornering operation is defined as calibration drive, and the change in the vehicle orientation in the calibration drive is determined.

One advantage of the present invention is that additional measuring components are dispensed with. It is therefore possible to calibrate the tire diameters on a public road at any time while driving and also on private property. The driving maneuver required for the calibration drive is compatible with the road traffic regulations and does not impede road traffic. Furthermore, the calibration may be carried out at any point in time and be repeated whenever and as often as desired.

The object is also achieved by a control system for determining the tire diameters of a motor vehicle by comparing at least two opposite wheels, sensors being installed to determine the change in the vehicle orientation in a calibration drive.

The measuring data of all four wheels of the vehicle are preferably set into relation with each other. During cornering, all four wheels exhibit different rotational wheel speeds, which are individually evaluable.

The calibration may be implemented by comparing the measured data of the calibration drive to expected values. In the process, the measured data of each wheel are set into relation with the measured data of the other wheels. The comparison with the expected values results in a correction factor for each wheel, which is set into relation with the correction factors of the other wheels.

For practical purposes, the rotational wheel speed and/or the steering angle and/or the steering-wheel angle are/is ascertained. Sensors are provided on the vehicle for that purpose. On the one hand, the measured values determined with the aid of the sensors are utilized as measured data, but it may also be used to determine the expected values on the other hand. The more measured values are available for evaluation, the more precise the calculation of the expected values for the wheel calibration.

This information obtained from the change in the vehicle orientation may be stored in at least one control device or is set into relation with the measured wheel rotation and the rotational wheel speed derived therefrom. In current motor vehicles the information is stored as numerical values on a vehicle CAN bus.

For the calibration it may already suffice to determine the expected values from a small number of measured data of the calibration drive. Data of the rotational wheel speed and/or the steering angle and/or the steering-wheel angle are utilizable for this purpose.

As an alternative or in addition, the expected values may be determined from the route information. The individual mutual angle of the roads traveled for the calibration drive, for instance, will be sufficient as route information.

As an alternative or in addition, the expected values may be determined from global positioning information, i.e., with the aid of satellite navigation.

For immediate calibration, the comparison of the expected values to measured data of the calibration drive may already be carried out during the calibration drive. As an alternative or in addition, the comparison of the expected values to measured data of the calibration drive may also be implemented following the calibration drive. For example, two calibration drives may be superposed in one driving maneuver.

A preferred driving maneuver for the calibration drive includes a reversal in driving direction, in particular what is generally known as a U-turn. It is conducted as a defined cornering operation, the drive away from the starting point and the drive in the direction of the starting point generally taking place in parallel in a finite range. The starting point and the end point are not identical in this case. A driving maneuver of this type is, for instance, a drive down a road, subsequent turning on the road, and a return drive on the road.

Alternatively, the calibration drive may encompass a closed route. Preferably, the starting point in this case may generally correspond to the end point. However, this need not necessarily be so. The deviation between the starting point and the end point should be small in comparison with the distance covered in the calibration drive. For example, the same parking spot is defined as starting/end point.

### BRIEF DESCRIPTION OF THE DRAWINGS

An exemplary embodiment of the present invention is explained in greater detail below, with reference to the accompanying figures.

FIG. 1 shows a sketch of a calibration drive in a first exemplary embodiment.

FIG. 2 shows an illustration of the driving maneuvers of the calibration drive according to the first exemplary embodiment.

FIG. 3 shows a sketch of a calibration drive in a second exemplary embodiment.

FIG. 4 shows an illustration of the driving maneuvers of the calibration drive according to the second exemplary embodiment.

FIG. 5 shows a flow chart of the control.

### DETAILED DESCRIPTION OF EXAMPLE EMBODIMENTS

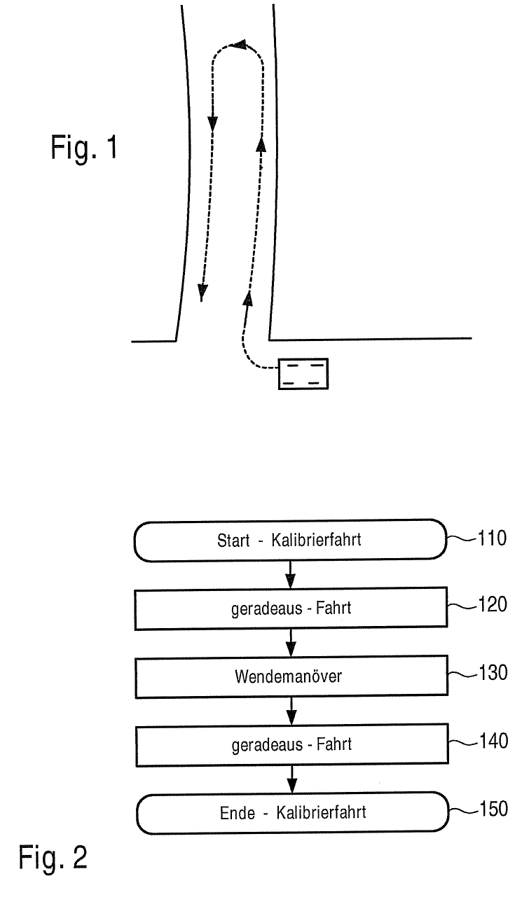

In a first exemplary embodiment according to FIG. 1, the motor vehicle is standing at an intersection and makes a right turn into the cross street. The control according to the example embodiment of the present invention for determining the tire diameters includes an approximate size of the tire diameter, e.g., with a deviation of 10%. The calibration drive begins in method step 110 (FIG. 2). In method step 120, the motor vehicle is driving for some ten meters in a generally straight line, turns on the road in method step 130, and returns along the same road in method step 140. The calibration drive ends with method step 150.

Using the measured data from the wheel tachometer and the steering angle meter or steering-wheel angle meter and proceeding on the assumption of the initially incorrect tire diameters, the vehicle position and driving direction are determined in a continuous manner by approximation. The calibration function determines that, following a likely turning maneuver in method step 130, a return along the same roads will take place again. It determines a section where, on the way back in method step 140, the motor vehicle must have traveled parallel to the drive out according to method step 110. With the aid of the angular deviation between the estimated driving direction and proceeding on the assumption that the parallel ride must have taken place in a 180° opposite direction, the error in the tire diameters is calculated directly. The correlation between angular deviation and error in the tire diameters is linear.

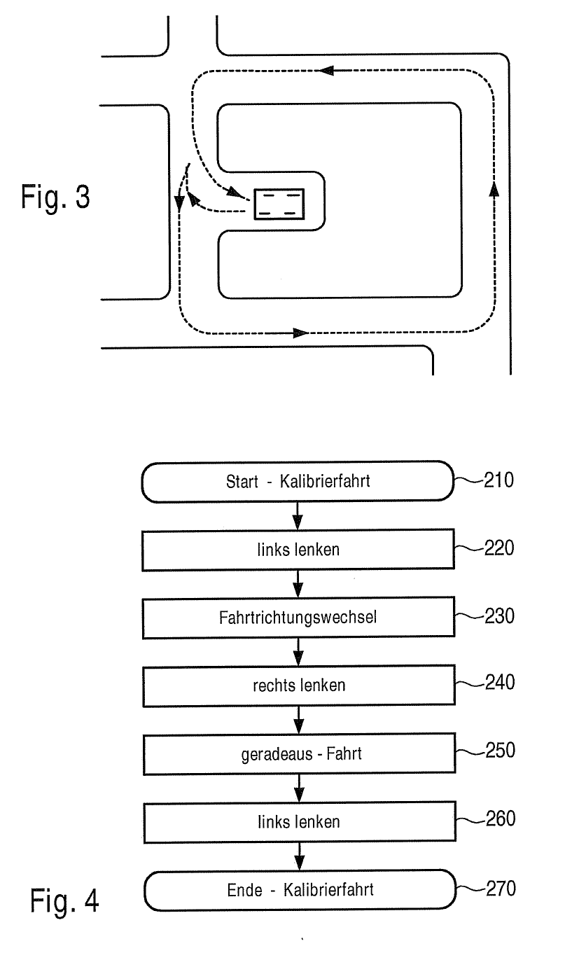

In a second exemplary embodiment according to FIG. 3, the motor vehicle is standing in a marked parking space. The calibration drive begins in method step 210. The motor vehicle backs out of the parking space, turns the steering wheel to the left in method step 220, changes the driving direction in method step 230, counter-steers to the right in method step 240, then drives straight ahead in method step 250 and turns into a street in method step 260. It drives around the apartment block once, with an interruption, for example, the maneuvers of driving straight ahead in method step 250 and turning left in method step 260 being repeated several times; the motor vehicle returns and once again comes to a standstill in the same marked parking space. The calibration drive ends in method step 270.

Using the measured data from the wheel tachometer and the steering-angle meter or steering-wheel angle meter and proceeding on the assumption of the initially incorrect tire diameters, the vehicle position and driving direction are continuously determined by approximation. Following the standstill in the parking spot at the very latest, the final vehicle angle is compared to the starting vehicle angle. Using the angular deviations between the estimated driving direction and the assumption that an approximately 0° change in orientation should exist at standstill in the parking space, a direct calculation of the error in the wheel diameter is carried out. The correlation between angular deviation and error in the tire diameters is linear.

In addition, the deviation of the estimated location at the end of the drive is compared in method step 270 with the location at the start of the calibration drive in method step 210, and the assumed tire diameter is adapted in such a way that the error becomes minimal.

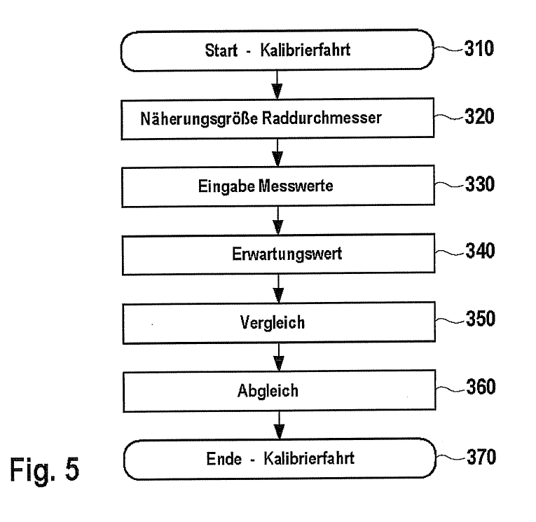

FIG. 5 shows a flow chart of a method according to the present invention for determining the tire diameters of a motor vehicle. Following the start of the calibration drive in step 310, the approximation variables in step 320 for the tire diameters are provided from a memory. Various measured values ascertained via sensors are incorporated in step 330 during the calibration drive. A few measured values are used in step 340 to draw up expected values for the vehicle orientation and also for each reference wheel. The expected values are compared to the remaining measured values in step 350, and an individual error is determined for each reference wheel. The actual tire diameter is determined via an adjustment in step 360 in comparison with the other reference wheels. The adjustment in step 360 may be implemented even before the calibration drive ends in step 370, thereby ending the calibration drive.

1-15. (canceled)

16. A method for determining diameters of tires of a motor vehicle by comparing at least two opposite wheels, the method comprising:
defining a driving maneuver having at least one cornering operation as a calibration drive; and
determining a change in the vehicle orientation in the calibration drive.

17. The method as recited in claim 16, further comprising:
determining wheel speed.

18. The method as recited in claim 16, further comprising:
determining a steering angle.

19. The method as recited in claim 16, further comprising:
determining a steering-wheel angle.

20. The method as recited in claim 16, wherein measured data of the calibration drive are compared to expected values.

21. The method as recited in claim 20, wherein the expected values are determined from measured data of the calibration drive.

22. The method as recited in claim 20, wherein the expected values are determined from route information.

23. The method as recited in claim 20, wherein the expected values are determined from global positioning information.

24. The method as recited in claim 20, wherein the comparison of the expected values with measured data of the calibration drive is implemented during the calibration drive.

25. The method as recited in claim 20, wherein the comparison of the expected values with measured data of the calibration drive is implemented following the calibration drive.

26. The method as recited in claim 20, wherein the calibration drive includes a reversal in driving direction.

27. The method as recited in claim 20, wherein the calibration drive encompasses a closed route.

28. The method as recited in claim 27, wherein a starting point of the closed route corresponds to an end point of the closed route.

29. A control for determining tire diameters of a motor vehicle by comparing at least two opposite wheels, comprising:
sensors adapted to determine a change in vehicle orientation in a calibration drive.

30. A control as recited in claim 29, wherein the sensors are at least one of wheel tachometers, steering-angle meters, and steering-wheel angle meters.
